(19) United States
(12) Patent Application Publication
(10) Pub. No.: US 2012/0159044 A1
(43) Pub. Date: Jun. 21, 2012

(54) NON-VOLATILE MEMORY SYSTEM WITH BLOCK PROTECTION FUNCTION AND BLOCK STATUS CONTROL METHOD

(75) Inventor: Ji Hyae BAE, Icheon-si (KR)

(73) Assignee: HYNIX SEMICONDUCTOR INC., Icheon-si (KR)

(21) Appl. No.: 13/219,614

(22) Filed: Aug. 27, 2011

(30) Foreign Application Priority Data
Dec. 21, 2010 (KR) 10-2010-0131301

(51) Int. Cl. G06F 12/02

(52) U.S. Cl. 711/103; 711/E12.008

(57) ABSTRACT

A non-volatile memory system with a block protection function includes a memory area including a first memory area including a plurality of blocks and a second memory area, and a controller configured to record data, which corresponds to status information on the plurality of blocks, in the second memory area, and read the data from the second memory area.

### CROSS-REFERENCES TO RELATED APPLICATION

The present application claims priority under 35 U.S.C. §119(a) to Korean application number 10-2010-0131301, filed on Dec. 21, 2010, in the Korean Intellectual Property Office, which is incorporated herein by reference in its entirety.

### BACKGROUND

1. Technical Field

The present invention relates generally to a memory system, and more particularly, to a non-volatile memory system with a block protection function and a block status control method.

2. Related Art

A non-volatile memory apparatus retains data stored in memory cells even when power is off.

An erase operation is performed in a non-volatile memory apparatus in a specific unit, for example, in block units. To prevent altering of data stored in a specific unit of block by an erroneous command, a flash memory apparatus is equipped with a block protection function.

Each block in a non-volatile memory apparatus with the block protection function supports a lock status, an unlock status, and a lock-down status.

FIG. 1 illustrates a block status control concept in a non-volatile memory system with a block protection function.

Each of the blocks included in a non-volatile memory apparatus supports three statuses, that is, a lock status, an unlock status, and a lock-down status.

A block in a lock status is prohibited from the program, erase or the like operations. The block in a lock status may be changed to an unlock status or a lock-down status. A block in an unlock status is permitted with program, erase or the like operations performed to/from a memory cell included in the block. When the block in the unlock status is changed to a lock-down status, it is not possible for the block to return to the lock status or the unlock status.

In order to control the block statuses such as the lock status, the unlock status, and the lock-down status, a flash memory apparatus controls these block statuses using a register included in a controller as a storage space for storing the status of the block.

FIG. 2 is a configuration diagram of a general non-volatile memory system.

Referring to FIG. 2, the general non-volatile memory system includes a control apparatus 110 which is connected to a memory cell array 100 to program data to the memory cell array 100, erase the data of the memory cell array 100, or read the data from the memory cell array 100.

The control apparatus 110 includes a controller 112 and a register 114 having a plurality of storage spaces. The control apparatus 110 includes an input control unit, an output control unit, and an address decoder.

The input control unit selects a corresponding storage space from the storage spaces of the register 114 through the address decoder and stores block status information in the selected storage space as a request for a change in an address and a status of a specific block is received from a host (not shown).

The output control unit accesses the corresponding storage space of the register 114 through the address decoder and reads the status information of the block, for which the status check has been requested, as a request for a check of the address and the status of the specific block is received from the host.

FIG. 3 is a flowchart of a block status change method in the general non-volatile memory system.

Referring to FIG. 3, a request to change the address and the status of a specific block is received from a host in step S101. The controller 112 decodes the received request command in step S103 and loads a start address in step S105 and an end address in step S107 of the block that would be subjected to a status change.

In step 109, the controller 112 accesses the register 114 to change the status of the block. The status change process of step 109 is repeated while increasing the address in step S113 until it is determined in step S111 that it has reached the end address.

FIG. 4 is a flowchart of a block status check method in the general non-volatile memory system.

A command to check the address and status of a specific block is inputted from a host in step S201, and the controller 112 decodes the command in step S203 and loads the address of the block subjected to a status check in step S205. The controller 112 reads the status information of the block corresponding to the address from the register 114 in step S207.

When the three statuses of each block is represented by two digit binary number (Lock=01, Unlock=00, and Lock-Down=11), a 2-bit storage space is needed to store the block status of each block. Then, when there are N number of blocks in the memory cell array 100, the total number of bits needed in a storage space would be 2N or twice the number of the blocks in the memory cell array 100. For example, when there are 512 blocks in the memory cell array 100 of 512M bits (i.e., the unit block size of 1M bit), the needed storage space would be 512*2 bits.

As described above, the storage space size for storing the status information is directly proportional to the number of blocks in a memory cell array 100, and, to accommodate a large number of memory blocks, a large capacity size register 114 is necessary.

In general, six transistors are needed to realize each storage space in the register 114. Then, the number of transistors needed, for example, for 512 blocks would be 512*2*6. In this manner, the register 114 of large size needed for storing the block statuses does not contribute to miniaturizing a non-volatile memory system for a higher degree of integration.

### SUMMARY

In an embodiment of the present invention, a non-volatile memory system with a block protection function includes: a memory area including a first memory area including a plurality of blocks and a second memory area; and a controller configured to record data, which corresponds to status information on the plurality of blocks, in the second memory area, and read the data from the second memory area.

In an embodiment of the present invention, a block status control method of a non-volatile memory system with a block protection function, which includes a controller and a memory area controlled by the controller and including a first memory area including a plurality of blocks and a second memory area, the block status control method includes the steps of: performing by the controller address mapping in response to a block address and a status change request signal; and recording status information in the second memory area according to address mapping information of the controller.

In an embodiment of the present invention, a block status control method of a non-volatile memory system with a block protection function, which includes a controller and a memory area controlled by the controller and including a first memory area including a plurality of blocks and a second memory area, the block status control method includes the steps of: performing by the controller address mapping in response to a block address and a status information check request signal; and reading status information from the second memory area according to address mapping information of the controller.

### BRIEF DESCRIPTION OF THE DRAWINGS

Features, aspects, and embodiments are described in conjunction with the attached drawings, in which:

FIG. 1 is a diagram explaining a block status control concept in a non-volatile memory system with a block protection function;

FIG. 2 is a configuration diagram of a general non-volatile memory system;

FIG. 3 is a flowchart explaining a block status change method in a general non-volatile memory system;

FIG. 4 is a flowchart explaining a block status check method in a general non-volatile memory system;

FIG. 5 is a configuration diagram of a non-volatile memory system according to an embodiment;

FIG. 6 is a diagram illustrating an exemplary controller applied to an embodiment;

FIG. 7 is a flowchart explaining a block status change method in a non-volatile memory system according to an embodiment; and

FIG. 8 is a flowchart explaining a block status check method in a non-volatile memory system according to an embodiment.

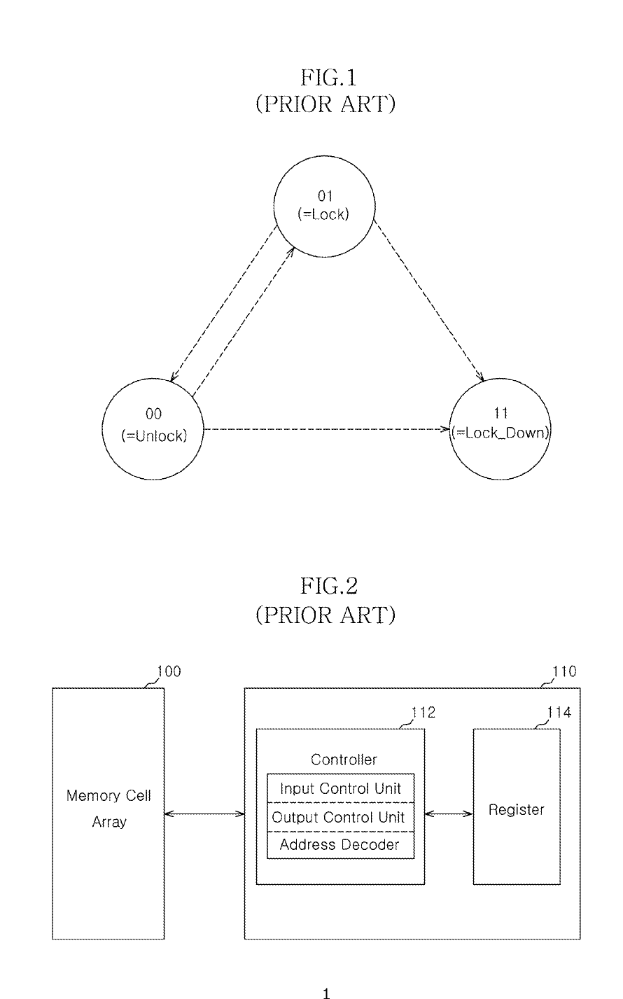

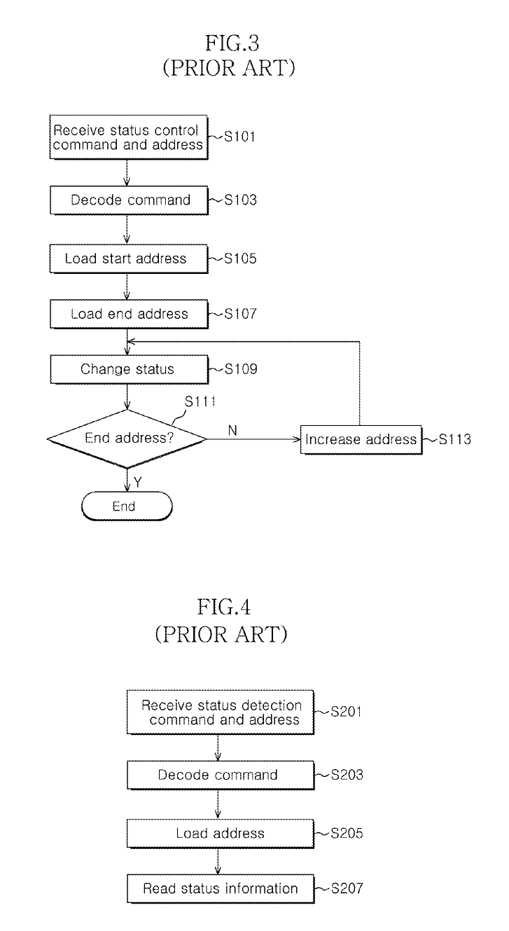

### DETAILED DESCRIPTION

Hereinafter, a non-volatile memory system with a block protection function and a block status control method according to exemplary embodiments of the present invention will be described in detail with reference to the accompanying drawings.

FIG. 5 is a configuration diagram of a non-volatile memory system according to an embodiment.

As illustrated in FIG. 5, a non-volatile memory system 20 having a block protection function according to an embodiment includes a memory area 210, a controller 220, an address decoder 230, and an input/output control unit (WD/SA) 240.

The memory area 210 includes a main memory area 212 having a plurality of blocks BLK0 to BLKn and a status storage memory cell area 214. The status storage memory cell area 214 may be configured to share a bit line together with the main memory area 212.

The controller 220 is configured to output an internal control signal according to an operation mode in response to a command provided from a host (not shown). The command provided from the host may include a block status storage command and a block status check command.

The address decoder 230 is configured to designate a row address and a column address of a memory block to be accessed under the control of the controller 220.

The input/output control unit 240 may include a write driver circuit WD and a sense amplifier circuit SA, and is configured to access a memory cell included in a corresponding block and record, erase, or read data as the row address and the column address are designated by the address decoder 230.

The controller 220 is configured to store the status information of a block in a specific memory cell of the status storage memory cell area 214 or read the status information from the specific memory cell to provide the host with the status information according to the command from the host.

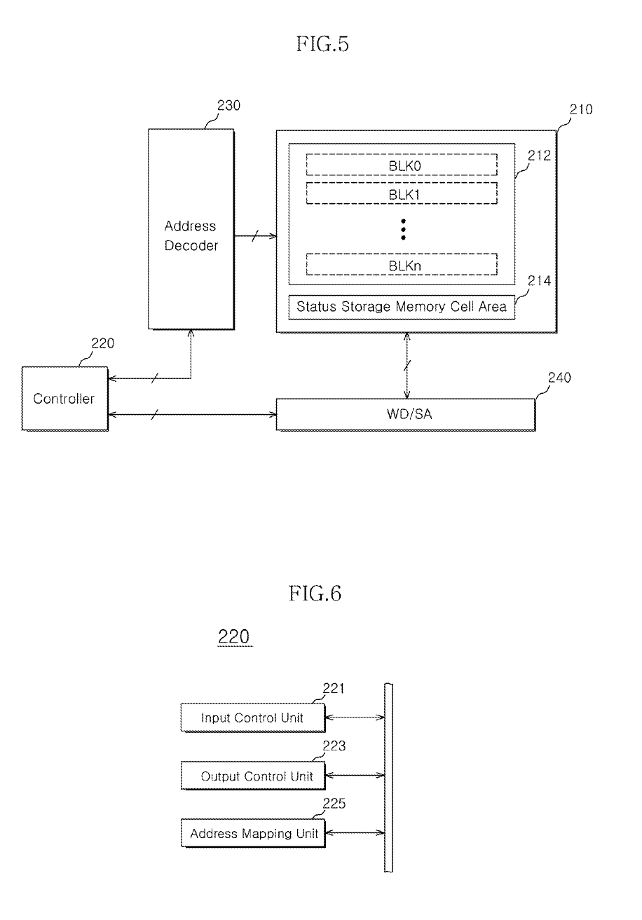

The controller 220 may be configured as illustrated in FIG. 6.

Referring to FIG. 6, the controller 220 includes an input control unit 221, an output control unit 223, and an address mapping unit 225.

The input control unit 221 is configured to record status information in a corresponding memory cell of the status storage memory cell area 214 with reference to the address mapping unit 225 as a status change command for a specific block is input from the host.

The output control unit 223 is configured to read data from the corresponding memory cell of the status storage memory cell area 214 with reference to the address mapping unit 225 as a status check command for the specific block is input from the host.

The address mapping unit 225 manages block addresses mapped with addresses of the status storage memory cell area 214 in which the status information of each block is stored.

For example, when the size of the main memory area 212 is 512M bits or 512 blocks with 1M bit block size, the memory cells of 8K bits may be connected to one word line.

In order to store the status information of 512 blocks, 512*2 (2¹⁰) memory cells would be necessary, and the memory cells of 8K bits (that is, 2¹³ memory cells) would be connected to one word line. In addition, as described above, a 2-bit storage space is necessary for storing the statuses of a block since each block has three statuses (Lock=01, Unlock=11, and Lock-Down=11).

In this regard, it can be understood that only the memory cells connected to one word line are sufficient for storing the status information of blocks. Consequently, it is possible to reduce the number of required transistors to ⅙ of the size required in the conventional art as described above according to which the status information is stored using a latch including six transistors.

Moreover, since only one word line is allocated to the status storage memory cell area 214, the address mapping unit 225 has only to manage block addresses and column addresses, which correspond to the block addresses, of the status storage memory cell area 214, without separately managing the row addresses of the status storage memory cell area 214.

In an embodiment, a unit memory cell constituting the main memory area 212 may include a non-volatile memory cell such as a flash memory cell or a phase change memory cell. In addition, a unit memory cell constituting the status storage memory cell area 214 may be substantially same as a unit memory cell of main memory area 212.

In this regard, the status storage memory cell area 214 can be accessed through an operation, which is substantially the same as an operation for accessing the main memory area 212 to record and output data, and record or output the status information of each block.

In the conventional art, the status information of blocks is stored using a status information storage register separately provided to a controller, and the peripheral circuits for reading status information from the register, for example, a write driver, a sense amplifier and the like are necessary.

However, in an embodiment, the status storage memory cell area 214 is provided to the memory area 210 as a dummy memory area, and the peripheral circuits used in the main memory area 212 can be used in the same manner, so that it is possible to simplify and miniaturize the configuration of the non-volatile memory system 20 and minimize an operation load thereof.

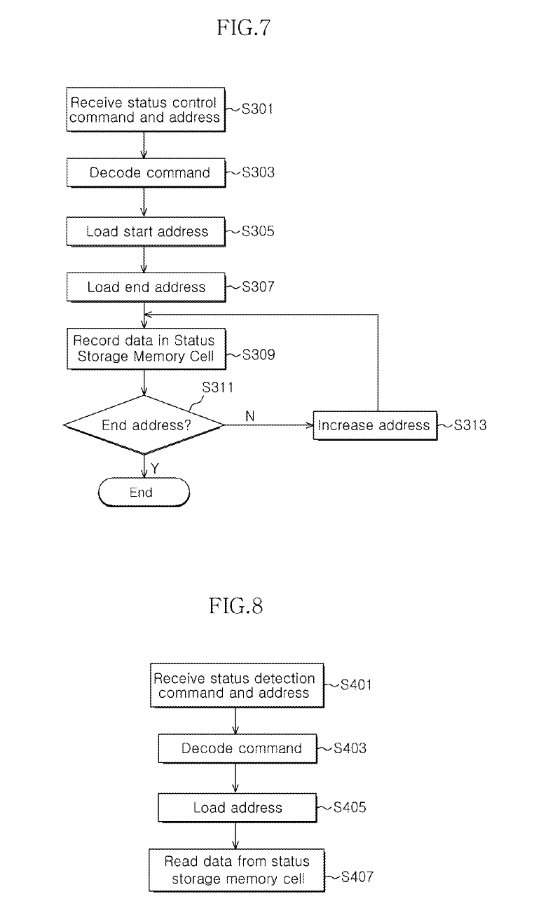

FIG. 7 is a flowchart of a block status change method in the non-volatile memory system according to an embodiment of the present invention.

Referring to the FIG. 7, a request to change an address and a status of a specific block is received from the host in step S301, and in step S303, the input control unit 221 of the controller 220 decodes the received command.

The input control unit 221 shown in FIG. 6 loads a start address in step S305 and an end address in step S307 of the status storage memory cell area 214, which have been mapped with the address of the block that is subjected to a status change, with reference to the address mapping unit 225, and provides the address decoder 230 with the start address and the end address (steps S305 and S307).

Thus, the address decoder 230 accesses a corresponding memory cell of the status storage memory cell area 214, so that data indicating a block status is recorded through the write driver circuit of the input/output control unit 240 in step S309. Such a status change process is repeated until the end address is reached in step S311 while increasing an address in step S313.

FIG. 8 is a flowchart of a block status check method in the non-volatile memory system according to an embodiment of the present invention.

A command for a checking an address and a status of a specific block is inputted from the host in step S401. The output control unit 223 of the controller 220 decodes the command in step S403.

The output control unit 223 loads an address of the status storage memory cell area 214, which have been mapped with the address of the block subject to a status check, with reference to the address mapping unit 225, and provides the address decoder 230 with the address in step S405.

Thus, the address decoder 230 designates a corresponding memory cell of the status storage memory cell area 214, so that the sense amplifier circuit of the input/output control unit 240 operates to read data and provide the controller 220 with the data in step S407.

In an embodiment, in the non-volatile memory system with the block protection function, the dummy memory cell area is added to the memory area and the status information of each block is stored in the dummy memory cell area. Consequently, it is possible to significantly reduce the number of elements used for status storage, and modify and check status information using a method substantially the same as a method for accessing the main memory area and recording/reading data. As a result, it is possible to achieve the efficient configuration and operation of the non-volatile memory system.

While certain embodiments have been described above, it will be understood to those skilled in the art that the embodiments described are by way of example only. Accordingly, the non-volatile memory system with a block protection function and the block status control method described herein should not be limited based on the described embodiments. Rather, the non-volatile memory system with a block protection function and the block status control method described herein should only be limited in light of the claims that follow when taken in conjunction with the above description and accompanying drawings.

What is claimed is:

1. A non-volatile memory system with a block protection function, comprising:
a memory area including a first memory area including a plurality of blocks and a second memory area; and
a controller configured to record data, which corresponds to status information on the plurality of blocks, in the second memory area, and read the data from the second memory area.

2. The non-volatile memory system according to claim 1, further comprising:
an address decoder configured to access the second memory area based on an address information provided from the controller.

3. The non-volatile memory system according to claim 1, wherein the controller is configured to store information of block addresses of the memory blocks and address mapping information of the second memory area corresponding to the block addresses.

4. The non-volatile memory system according to claim 3, wherein the controller comprises:
an address mapping unit configured to store the address mapping information; and
an input control unit configured to record data corresponding to status information of the second memory area with reference to the address mapping unit in response to status information storage information.

5. The non-volatile memory system according to claim 3, wherein the controller comprises:
an address mapping unit configured to store the address mapping information; and
an output control unit configured to read data from the second memory area with reference to the address mapping information in response to a status information check command.

6. The non-volatile memory system according to claim 1,
wherein the first memory area comprises a plurality of memory cells connected between a plurality of word lines and a plurality of bit lines, and
wherein the second memory area comprises a plurality of memory cells connected between one or more word lines and the bit line.

7. The non-volatile memory system according to claim 6, wherein the second memory area shares a bit line together with the first memory area.

8. The non-volatile memory system according to claim 1, wherein each of the plurality of memory cells provided in the second memory area and a memory cell provided to the first memory area are substantially same in structure.

9. The non-volatile memory system according to claim 1, wherein the status information includes a lock status, an unlock status, or a lock-down status.

10. A block status control method of a non-volatile memory system with a block protection function, which includes a controller and a memory area controlled by the controller and including a first memory area including a plurality of blocks and a second memory area, the block status control method comprising the steps of:
performing address mapping in response to a block address and a status change request signal; and
recording status information in the second memory area according to address mapping information of the controller.

11. The block status control method according to claim 10, wherein, in the step of performing the address mapping, a start address and an end address of the second memory area for recording status information are loaded in correspondence with the block address.

12. The block status control method according to claim 11, wherein, in the step of recording the status information, the status information is recorded while an address is increased from the start address to the end address.

13. A block status control method of a non-volatile memory system with a block protection function, which includes a controller and a memory area controlled by the controller and including a first memory area including a plurality of blocks and a second memory area, the block status control method comprising the steps of:
performing by the controller address mapping in response to a block address and a status information check request signal; and
reading status information from the second memory area according to address mapping information of the controller.

14. The block status control method according to claim 13, wherein, in the step of performing the address mapping, a start address and an end address for checking status information of the second memory area are loaded in correspondence with the block address.

15. The block status control method according to claim 14, wherein, in the step of reading the status information, the status information is read while increasing an address from the start address to the end address.
